(19) United States
(12) Patent Application Publication
(10) Pub. No.: US 2001/0004401 A1
(43) Pub. Date: Jun. 21, 2001

(54) Process for inspecting the quality of an article in particular one made of glass

(76) Inventors: Philippe Dubois, Mortefontaine (FR); Fabrice Gibrat, Chatillon (FR)

Correspondence Address: OLIFF & BERRIDGE, PLC, P.O. BOX 19928, ALEXANDRIA, VA, 22320, US

(21) Appl. No.: 09/734,717

(22) Filed: Dec. 13, 2000

(30) Foreign Application Priority Data
Dec. 15, 1999 (FR) FR 99 15841

(51) Int. Cl. G06K 9/00; G06K 9/46; G06K 9/66

(52) U.S. Cl. 382/142; 382/190

(57) ABSTRACT

The article, for example a glass bottle, may exhibit at least one feature, in particular a defect, visible from outside the article, from among features of different types T₁, . . . , Ti, . . . , Tₙ. In this process, acquisition of a digital image of the article is carried out, this image is processed so as to extract therefrom a region corresponding to this visible feature, the type of the visible feature is identified from among the various types Tₗ by calculating at least one discriminating parameter P₁, . . . , Pⱼ, . . . Pₙ characterizing the region, and the type of the feature is used to decide whether the quality of the article is adequate or inadequate. As appropriate, a reference parameter PR characterizing the region is calculated, this reference parameter PR is compared with a threshold parameter dependent on the type of the visible feature, and the result of this comparison is used to decide whether the quality of the article is adequate or inadequate.

The present invention relates to a process for inspecting the quality of an article, in particular one made of glass.

It applies especially to the inspection of glass containers such as bottles.

The state of the art already discloses a process for inspecting the quality of an article which may exhibit at least one feature, in particular a defect, visible from outside the article, from among features of different types T₁, . . . Ti, . . . , Tₙ, in which:

acquisition of a digital image of the article is carried out by means of a matrix camera, and

this image is processed by filtering and segmentation so as to extract therefrom a region corresponding to the visible feature.

Usually, a glass bottle, manufactured by a conventional molding process, may exhibit certain features visible from outside this bottle, corresponding to defects or otherwise. The most common types of feature are specified hereinbelow.

(a) type of feature not corresponding to a defect:

mark of the join plane of the mold for forming the bottle, commonly referred to as the “mold join”.

(b) types of feature corresponding to critical defects:

“flashing” formed by a projection external to the bottle, running in line with the mold join.

“bird swing” formed by a glass thread internal to the bottle, extending between two points of the internal surface of this bottle.

(c) types of feature corresponding to major defects.

“blister” formed by an air bubble in the wall of the bottle:

“inclusion” corresponding for example to fragments of lead, of refractory materials or to foreign bodies trapped in the mass of the bottle.

(d) type of feature corresponding to a minor defect:

“lap” of the external surface of the bottle.

These various types of feature are illustrated in the appended figures which will be described later.

Only the types of feature of paragraphs (b), (c) and (d) above constitute defects which may impair the quality of a bottle. The quality inspection process of the aforesaid type makes it possible to detect these defects by artificial vision, without contact with the inspected bottle.

To each defect there corresponds a region of the processed image.

It will be noted that the term “region” of a digital image refers to a set of adjoining pixels possessing a shared property not possessed by the neighboring sets. A region is therefore surrounded by a closed contour. A region is recognized as such solely on the basis of properties of the image, gray level, etc. For further information regarding image processing in general, reference may be made for example to “Techniques de l'Ingénieur”, 1996, volume “Informatique H3”, pages H3 608-2 et seq.

Usually, after extracting the region corresponding to the visible feature:

a reference parameter PR characterizing the region is calculated,

this reference parameter PR is compared with a threshold parameter, and

the result of this comparison is used to decide whether the quality of the article is adequate or inadequate.

The reference parameter associated with a region of the processed image is generally the number of pixels of this region which characterizes the size of the region. The threshold parameter therefore corresponds to a critical size of the region, that is to say to a number of pixels below which the defect is considered to be acceptable and above which the defect is considered to be unacceptable. When the defect is unacceptable, the defective bottle is generally extracted from the production line and then recycled by return to the start of the manufacturing chain in an upstream vessel of molten glass.

The number of pixels of a region does not make it possible to deduce the type of defect corresponding to this region. However, depending on whether the defect is of one type or of another, the critical size of the region of the image corresponding to this defect may vary. Thus, a lap (minor defect) is generally acceptable even if, after image processing, this lap generates a region of considerable size, whilst a bird swing (critical defect) is generally unacceptable even if, after image processing, this bird swing generates only a region of small size.

Conventionally, the inspection processes of the aforesaid type detect defective bottles on the basis of a threshold parameter shared by all the types of defect. Therefore, these conventional processes are generally either too strict or not strict enough having regard to certain types of defect.

U.S. Pat. No. 4,378,494 describes a process and a device for detecting defects in bottles. According to this process, a complete check of a bottle is made by successive sweeps by means of a camera comprising photodiodes arranged in line, that is to say producing an image in one dimension only. To carry out the successive sweeps, the bottle must be grasped with appropriate gripping means intended for presenting successive areas of the bottle in front of the linear camera.

This inspection process disturbs the possible path of the bottle on a conveyor since the former must be grasped at the time of the inspection. Moreover, the movements of the bottle between two successive sweeps give rise to errors and inaccuracies of location of each swept area. Therefore, two successive sweeps are not perfectly adjacent, thereby limiting the reliability of the process.

U.S. Pat. No. 5,815,198 describes a process and a device which are essentially adapted for detecting defects in fabrics. The detection and the identification of the defects are carried out by analyzing mathematical transforms calculated on the basis of parameters of a one-dimensional digital image constructed according to a fractal progression. Such a process is very poorly suited to the inspection of glassware products.

The object of the invention is to propose a process for inspecting the quality of an article in particular one made of glass, allowing accurate discrimination of defective articles as a function of the severity of the defects.

Accordingly, the subject of the invention is a process for inspecting the quality of an article, of the aforesaid type,

wherein:

the type of the visible feature is identified from among the various types Tᵢ by calculating at least one discriminating parameter P₁, . . . Pⱼ, . . . Pₙ characterizing the region,

the type of the feature is used to decide whether the quality of the article is adequate or inadequate.

According to other characteristics of this process:

a reference parameter PR characterizing the region is calculated,

this reference parameter PR is compared with a threshold parameter dependent on the type of the visible feature, and

the result of this comparison is used to decide whether the quality of the article is adequate or inadequate;

the reference parameter PR is the number of pixels of the region;

first and second sets of types Tᵢ of features are distinguished, they being such that any type Tᵢ of feature of the first set corresponds to an invalidating defect and any type Tᵢ of feature of the second set corresponds to a defect whose invalidating nature depends on the reference parameter PR;

a third set of types Tᵢ of features is distinguished, it being such that no type Tᵢ of feature of the third set corresponds to a possibly invalidating defect;

to identify the type of the visible feature from among the types Tᵢ of feature,

a) with each discriminating parameter Pⱼ there is associated,

a fuzzy discriminating parameter PⱼF, and

for each type Tᵢ of feature, a possibility distribution Dᵢⱼ over the set of possible values of the discriminating parameter Pⱼ, this distribution expressing the degree with which it is possible for a type Tᵢ of feature to be identified in view of the discriminating parameter Pⱼ,

b) the compatibility of the fuzzy parameter PⱼF with the possibility distribution Dᵢⱼ is evaluated so as to deduce the possibility Aᵢⱼ of having identified the type Tₗ of feature in view of the discriminating parameter Pⱼ;

at least two distinct discriminating parameters Pⱼ, Pₖ are calculated and

for each type Tᵢ of feature, the two corresponding possibilities Aᵢⱼ, Aᵢₖ of having identified the type Tᵢ of feature in view of the two discriminating parameters Pⱼ, Pₖ are calculated and the minimum possibility min (Aᵢⱼ, Aₗₖ) of having identified the type Tᵢ of feature is determined, and

the minimum possibilities min (Aᵢⱼ, Aᵢₖ) of each type Tᵢ of feature are intercompared so as to decide which of the types T₁ of feature corresponds to the visible feature;

the type of the visible feature is considered to be the type Tᵢ of feature having the highest minimum possibility min(Aᵢⱼ, Aᵢₖ);

the type of the visible feature is considered to be the type Tᵢ of feature having the highest minimum possibility min(Aᵢⱼ, Aᵢₖ), on condition that this highest minimum possibility min (Aᵢⱼ, Aᵢₖ) is greater than a predetermined threshold;

the type of the visible feature is considered to be the type Tᵢ of feature having the highest minimum possibility min(Aᵢⱼ, Aᵢₖ), on condition that the difference between the highest minimum possibility min (Aᵢⱼ, Aᵢₖ) and the lowest minimum possibility min (Aᵢⱼ, Aᵢₖ) is greater than a predetermined threshold;

should it be decided that the quality of the article is inadequate, the latter is sent to a recycling or rejection chain which depends on the type Tᵢ of feature identified;

each discriminating parameter of a region is chosen from among parameters characterizing the aspect ratio of the region, the orientation of this region with respect to a reference direction, the shape of the region with respect to a reference shape, such as a rectangle encompassing this region or the perforated look of the region;

at least three distinct types Tᵢ of features are defined;

the article is made of glass and constitutes for example a container;

the process is implemented by a computer program.

The invention will be better understood on reading the description which follows given merely by way of example and whilst referring to the drawings, in which:

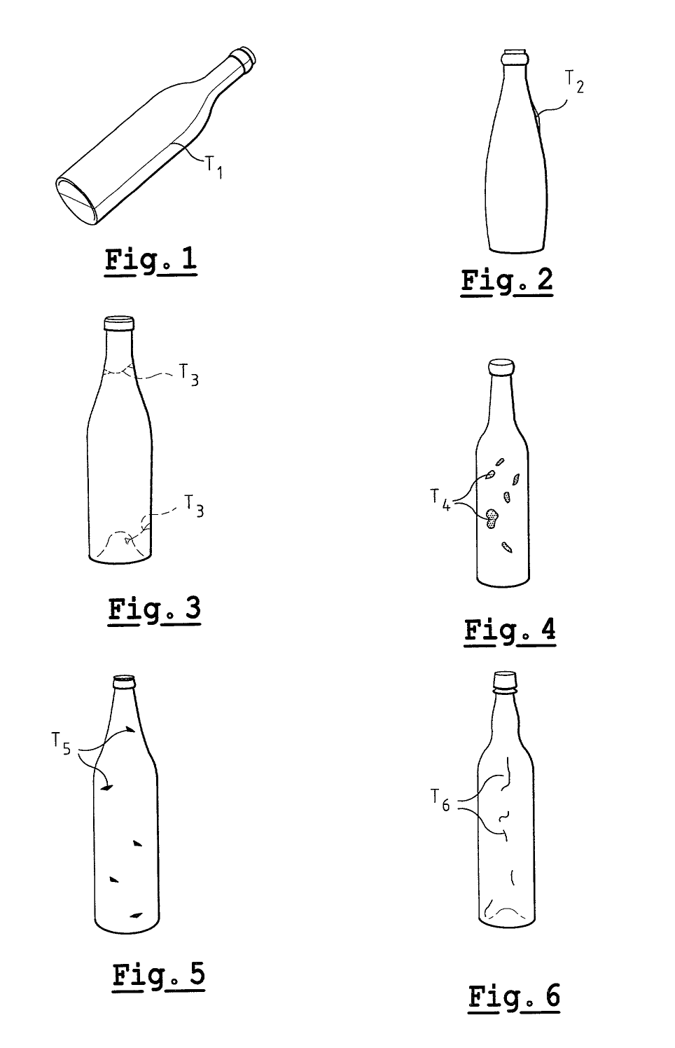

FIGS. 1 to 6 are views of glass bottles exhibiting features visible from outside them, it being possible to inspect the quality of these bottles by a process according to the invention;

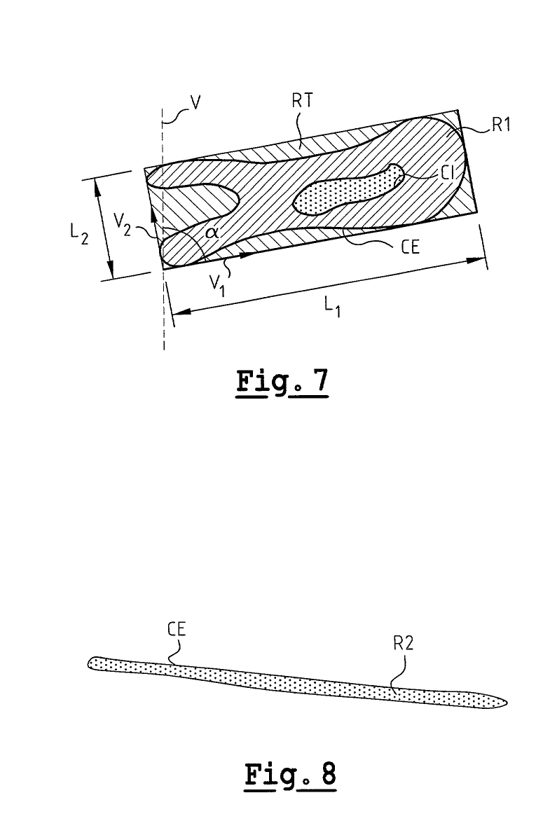

FIGS. 7 and 8 are diagrammatic views of regions of processed images corresponding to features as illustrated in FIGS. 1 to 6;

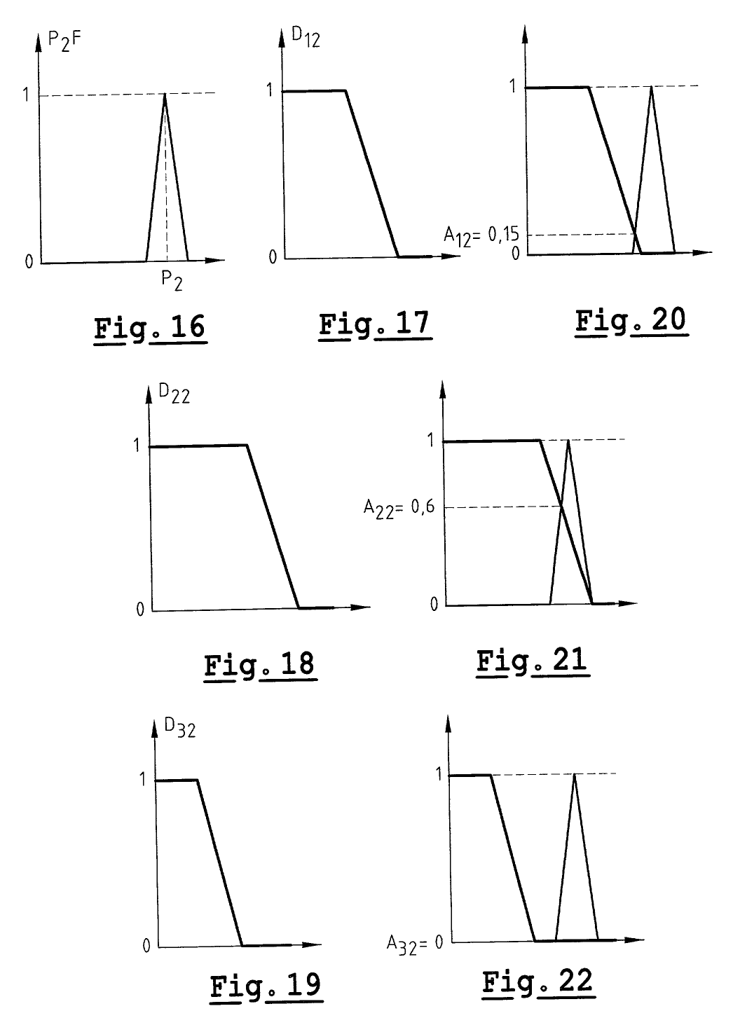

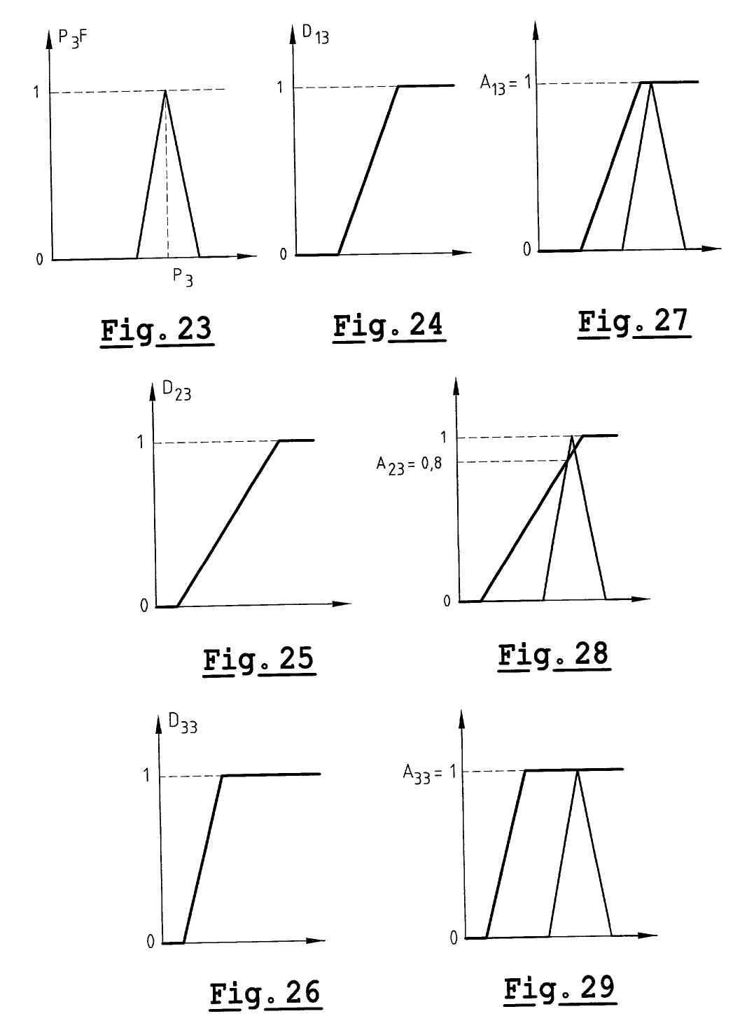

FIGS. 9 to 29 are diagrams illustrating fuzzy logic mathematical tools implemented for identifying the type of a feature as illustrated in FIGS. 1 to 6;

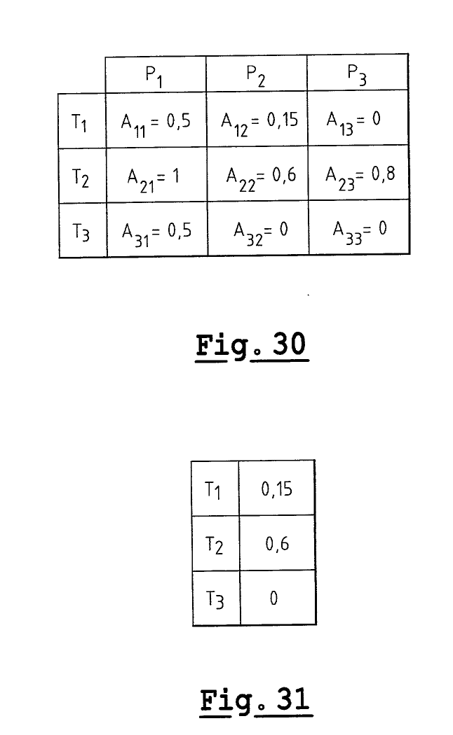

FIGS. 30 and 31 are tables collating results obtained by the fuzzy logic tools illustrated in FIGS. 9 to 29.

Represented in FIGS. 1 to 6 are bottles exhibiting features visible from outside them. FIG. 1 illustrates a bottle on which a mold join T₁ is visible. FIG. 2 illustrates a bottle in which a flashing T₂ is visible. FIG. 3 illustrates a bottle in which bird swings T₃ are visible, a first bird swing extending in the region of the neck of the bottle and the second bird swing extending in the region of the base of this bottle. FIG. 4 illustrates a bottle exhibiting blisters T₄. FIG. 5 illustrates a bottle exhibiting inclusions T₅. FIG. 6 illustrates a bottle exhibiting laps T₆.

The mold join T₁ illustrated in FIG. 1 does not correspond to a defect. The features T₂ to T₆ illustrated in FIGS. 2 to 6 correspond to defects which, depending on their severity, may be incompatible with the quality required for the bottles.

FIGS. 1 to 6 therefore each illustrate a different type of feature. Of course, a glass bottle may exhibit other features visible from outside it different from those illustrated by way of example in FIGS. 1 to 6.

The process according to the invention makes it possible to inspect the quality of an article, such as a glass bottle, which may exhibit at least one feature, in particular a defect, visible from outside the article from among features of different types T₁, . . . , Tᵢ, . . . , Tₙ (i is a natural integer≧1), such as the types of feature illustrated in FIGS. 1 to 6.

According to this process, firstly, a digital image of the bottle is acquired, preferably at high resolution, by means of at least one matrix camera. This type of camera makes it possible to acquire an image in two dimensions referred to as vertical and horizontal respectively.

The image is then processed so as to extract therefrom, should a visible feature be present, a region corresponding to this visible feature.

The digital image is processed in a manner known per se, in particular by filtering and segmenting this image, in such a way as to extract any region corresponding to a visible feature.

A filtering operation conventionally comprises:

the enhancing of the homogeneity inside the regions (noise reduction);

the preservation of the shape of the regions;

the enhancing of the differences between the pixels belonging to adjacent regions (heightening of contrast).

A segmentation operation conventionally consists in extracting the regions constituting an image with a view in particular to measuring parameters which characterize them.

Represented diagrammatically in FIGS. 7 and 8 are two regions R1 and R2 corresponding to two visible features, obtained after image processing.

After extracting at least one region, the type of the visible feature (corresponding to the region extracted from the image) is identified from among the various types Tᵢ by calculating at least one discriminating parameter P₁, . . . , Pⱼ, . . . , Pₙ (j is a natural integer≧1) characterizing the region.

Next, the type of the feature is used to decide whether the quality of the article is adequate or inadequate.

Accordingly, first, second and third sets of types Tᵢ of features are preferably distinguished in the following way.

Any type Tᵢ of feature of the first set corresponds to an invalidating defect. Flashings and bird swings preferably belong to the first set.

Any type Tᵢ of feature of the second set corresponds to a defect whose invalidating nature depends on a reference parameter PR characteristic of the region. Blisters, laps and inclusions preferably belong to the second set.

No type Tₗ of feature of the third set corresponds to a possibly invalidating defect. Join plane marks preferably belong to the third set.

If the type Tᵢ of feature belongs to the first set of invalidating defects, it is decided that the quality of the bottle is inadequate.

If the type Tᵢ of feature belongs to the third set, it is decided that the quality of the bottle is adequate.

If the type Tᵢ of feature belongs to the second set of possibly invalidating defects, firstly, the reference parameter PR, which is preferably the number of pixels of the region, is calculated and then the reference parameter PR is compared with a threshold parameter whose value depends on the type of the visible feature.

The threshold parameter is a threshold number of pixels of the relevant region, beyond which this region corresponds to a defect which is incompatible with the quality required of the bottle. Of course, the threshold parameter will have a different value depending on whether the type of feature identified is a flashing, a bird swing, a blister, an inclusion, a lap, etc.

Finally, the result of the comparison between the reference parameter PR and the threshold parameter is used to decide whether the feature identified is incompatible with the quality required of the bottle.

When the quality of the bottle is considered to be inadequate because it exhibits a feature corresponding to a severe defect which is incompatible with the quality of this bottle, the bottle is recycled or rejected depending on the type of defect identified. Thus, if the type of defect is for example a flashing, a bird swing, a blister or a lap, the bottle will be recycled by return to the start of the manufacturing chain, in particular into an upstream vessel of molten glass. By contrast, if the type of defect is an inclusion, that is to say a foreign body accidentally trapped in the mass of the bottle, the latter is not recycled into the same manufacturing chain so as not to contaminate the vessel of molten glass upstream of the chain.

Furthermore, after having identified the type of the visible feature, if this feature is a defect, it is possible to act in feedback mode on the bottle manufacturing chain, especially on the adjusting of the mold for manufacturing this bottle so as to correct the defect.

A process for identifying the type of the visible feature from among the types Tₗ of feature, using fuzzy logic, will be indicated hereinbelow.

As far as the general principles of fuzzy logic are concerned, reference may usefully be made to the work in the collection “Que sais-je?”, “La Logique Floue” by Bernadette BOUCHON-MEUNIER, University Press of France, corrected second edition, April 1994.

Examples of discriminating parameters which may characterize an image region will firstly be given.

In FIG. 7, conventional calculations have been used to determine the rectangle RT encompassing the region R1. The largest dimension of this rectangle L₁ is parallel to the principal direction of the region R1 which is determined through a conventional calculation of eigenvectors (V₁, V₂) associated with the region R1. The region R1 is delimited, in the example illustrated, by an internal contour CI and an external contour CE.

L₂ being the smallest dimension of the encompassing rectangle RT, it is possible to define a discriminating parameter P₁ by the ratio L₂/L₁. This ratio P₁ characterizes the aspect ratio of the region R1.

The greater the aspect ratio of this region R1, the more the ratio P₁ tends to 0.

Another discriminating parameter P2 can be defined by the angle α between a vertical reference direction V and the eigenvector V₁ parallel to the principal direction of the region R1. This discriminating parameter P₂ characterizes the general orientation of the region R1.

Another discriminating parameter P₃ can be defined as the ratio: number of pixels of the region R1/number of pixels of the encompassing rectangle RT. This ratio P₃ characterizes the capacity of the region R₁ to fill the encompassing rectangle RT. The more the ratio P₃ tends to 1, the more rectangular is the shape of the region R1 and the fewer holes this region R1 exhibits.

Another discriminating parameter P₄ can be defined as the ratio: number of pixels of the contour CI of the region R1/number of pixels of the contour CE of the region R1. This ratio P₄ makes it possible to assess the perforated look of the region R1. The more P₄ tends to 1, the more perforated is the region R1. The more P₄ tends to 0, the more solid is the region R1.

Another discriminating parameter P₅, especially suited to a region corresponding to a lap, such as the region R2 represented in FIG. 8, can be defined as the ratio: number of pixels of the contour CE/number of pixels of the region R2. The more P₅ tends to 1, the more a lap is characterized. The more P₅ tends to 0, the more an inclusion is characterized.

The type of the visible feature is identified from among the types Tᵢ of feature in the following manner.

Firstly, with each discriminating parameter Pⱼ there is associated:

a fuzzy discriminating parameter PⱼF conveying imprecise knowledge of Pⱼ(“roughly Pⱼ), and

for each type Tᵢ of feature, a distribution of possibilities Dᵢⱼ over the set of possible values of the discriminating parameter Pⱼ, this distribution expressing the degree with which it is possible for a type Tᵢ of feature to be identified in view of the discriminating parameter Pⱼ.

The fuzzy discriminating parameter PⱼF is defined in a conventional manner by a function of triangular form such as alluded to in the aforesaid work “La Logique Floue”, chapter II, paragraph II, point 3.

The possibility distribution Dᵢⱼ is a function defined in a conventional manner as indicated in the aforesaid work “La Logique Floue”, chapter III, paragraph I, point 2.

FIGS. 9 to 29 relate to an example in which three discriminating parameters P₁ to P₃ have been considered, these not necessarily being the discriminating parameters alluded to by way of example earlier and bearing the same index. Furthermore, the example of FIGS. 9 to 29 takes account of only three types Tᵢ of defect.

Illustrated in FIGS. 9, 16 and 23 are fuzzy discriminating parameters P₁F to P₃F associated with the discriminating parameters P₁ to P₃. These FIGS. 9, 16 and 23 convey the fact that the discriminating parameter P₃ is known imprecisely. The fuzzy discriminating parameter P₃F conveys the concept of “roughly Pⱼ”.

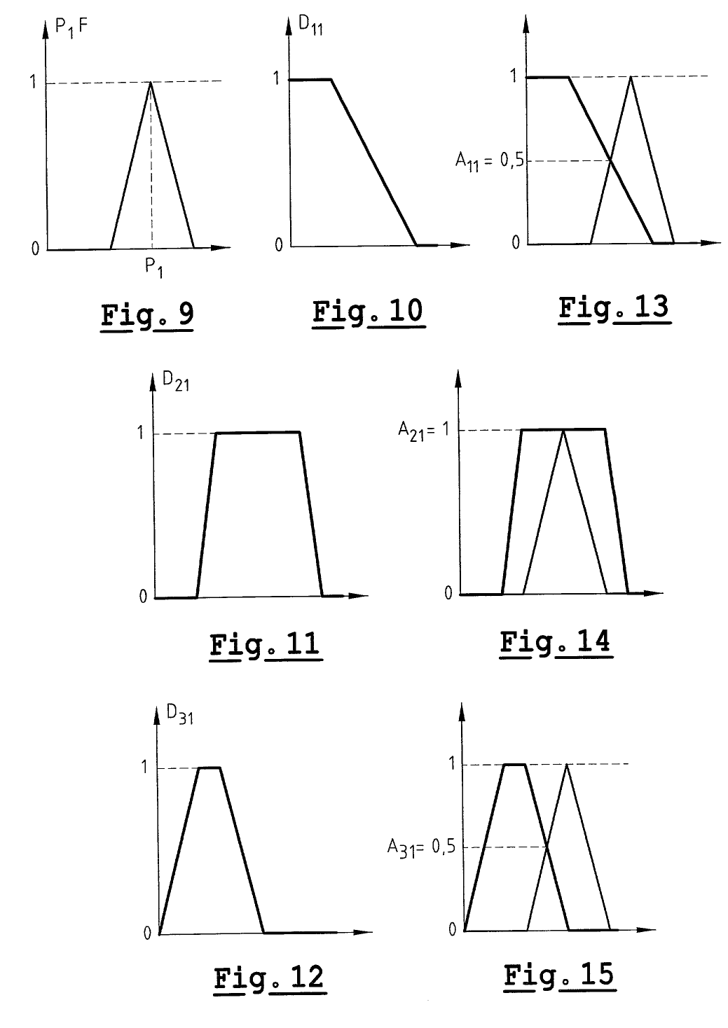

Represented in FIGS. 10 to 12, 17 to 19 and 24 to 26 are three possibility distributions Dₗⱼ corresponding to the three types Tᵢ of defect and respectively associated with each of the discriminating parameters Pᵢ(Dₗⱼ=1: the feature is certainly of type Tᵢ in view of the parameter Pⱼ; Dᵢⱼ=0: it is impossible for the feature to be of type Tᵢ in view of the parameter Pⱼ).

After having established the fuzzy discriminating parameters PⱼF and the possibility distributions Dᵢⱼ, the compatibility of each fuzzy parameter PⱼF with each possibility distribution Dᵢⱼ is evaluated so as to deduce the possibility Aₗⱼ of having identified the type T₁ of feature in view of the discriminating parameter Pⱼ.

The definitions of “compatibility of a fuzzy parameter with a possibility distribution” and of “possibility” are conventional and recalled for example in the aforesaid work “La Logique Floue”, chapter III, paragraph IV.

FIGS. 13 to 15, 20 to 22 and 27 to 29 illustrate the compatibility of the fuzzy parameters P₁F to P₃F with the possibility distributions Dₗⱼ illustrated in FIGS. 10 to 12, 17 to 19 and 24 to 26. The possibilities Aᵢⱼ, corresponding to the examples illustrated in the figures, are indicated in FIGS. 13 to 15, 20 to 22 and 27 to 29.

Generally, at least two distinct discriminating parameters Pⱼ, Pₖ are calculated.

In what follows, the way to determine the type of the visible feature from among the types Tᵢ of feature will be specified, considering only two distinct discriminating parameters Pⱼ, Pₖ, the process extrapolating without difficulty to a larger number of discriminating parameters.

For each type Tᵢ of feature, the two corresponding possibilities Aₗⱼ, Aₗₖ of having identified the type Tᵢ of feature in view of the two discriminating parameters Pⱼ, Pₖ are calculated, and the minimum possibility min (Aₗⱼ, Aᵢₖ) of having identified the type Tᵢ of feature is determined.

Next, the minimum possibilities min (Aᵢⱼ, Aᵢₖ) of each type Tₗ of feature are intercompared so as to decide which of the types Tᵢ of feature corresponds to the visible feature. In FIG. 30, the possibilities Aᵢⱼ of having identified a type Tᵢ of feature in view of the discriminating parameter Pⱼ have been collated in a table, in the case of the example of FIGS. 9 to 29.

Represented in FIG. 1 is the table collating, for each type Tᵢ of feature, the minimum possibility from among the possibility values appearing in the table of FIG. 30.

The table of FIG. 31 is therefore read as follows: there are 15% of possibilities that the visible feature is of type T₁, 60% of possibilities that the visible feature is of type T₂ and it is impossible for the visible feature to be of type T₃.

To deduce the type of the visible feature, one may decide that the type of this feature is the type Tᵢ having the highest minimum possibility min (Aᵢⱼ, Aᵢₖ) . In the case of FIG. 31, the type identified is then the type T₂.

As a variant, the type of the visible feature may be considered to be the type Tᵢ of feature having the highest minimum possibility min (Aᵢⱼ, Aᵢₖ), on condition that this highest minimum possibility min (Aᵢⱼ, Aₗₖ) is greater than a predetermined threshold.

This may lead to no type Tᵢ of feature being recognized. In this case, there will be provision to discard or to retain the inspected bottle accordingly.

According to another variant, the type of the visible feature can be considered to be the type Tₗ of feature having the highest minimum possibility min (Aᵢⱼ, Aᵢₖ), on condition that the difference between the highest minimum possibility min (Aᵢⱼ, Aᵢₖ) and the lowest minimum possibility min (Aᵢⱼ, Aᵢₖ) is greater than a predetermined threshold.

This can also lead to no type Tₗ of feature being recognized.

Once the type Tᵢ of the feature has been identified, the reference parameter PR (number of pixels of the region) is compared, as appropriate, with the threshold parameter associated with the type Tᵢ.

As a function of the result of this comparison, it is possible to decide whether the quality of the bottle is adequate or inadequate.

Preferably, the process according to the invention is implemented by at least one computer program.

Among the advantages of the invention, it will be noted that the latter makes it possible to inspect the quality of articles, in particular ones made of glass, by accurately discriminating between defective bottles as a function of the type of defect and of the severity of this defect.

The acquisition of an image by means of a matrix camera (two-dimensional image) makes it possible to avoid multiple sweeps of the article to be inspected which are carried out in the state of the art by means of a linear camera. In the invention, a region (set of pixels), corresponding to a feature of the article, is acquired from a single image. In order that each feature of an article can be viewed in totality by a matrix camera, it is possible to resort to three or four matrix cameras arranged around the article.

The inspection process according to the invention makes it possible to regulate the glass bottle manufacturing chain as a function of the type of defect identified, in particular by acting on the control of the bottle molding means. According to the type of defect identified, a particular station of the chain will be acted on.

Of course, the inspection process according to the invention can be applied to glass articles other than bottles, in particular various containers. Moreover, this process can be applied to articles manufactured from materials other than glass.

Finally, it will be noted that the identification of the type of the visible feature from among the various types Tᵢ can be carried out by processing the discriminating parameters Pⱼ characterizing the region with mathematical tools other than those proposed by fuzzy logic theory.

1. A process for inspecting the quality of an article which may exhibit at least one feature, in particular a defect, visible from outside the article, from among features of different types T₁, . . . , Tᵢ, . . . , Tₙ, in which:
acquisition of a digital image of the article is carried out by means of a matrix camera, and
this image is processed by filtering and segmentation so as to extract therefrom a region (R1, R2) corresponding to the visible feature,
wherein:
the type of the visible feature is identified from among the various types Tᵢ by calculating at least one discriminating parameter P₁, . . . , Pⱼ, . . . , Pₙ characterizing the region,
the type of the feature is used to decide whether the quality of the article is adequate or inadequate.

2. The process as claimed in claim 1, wherein
a reference parameter PR characterizing the region (R1, R2) is calculated,
this reference parameter PR is compared with a threshold parameter dependent on the type of the visible feature, and
the result of this comparison is used to decide whether the quality of the article is adequate or inadequate.

3. The process as claimed in claim 2, wherein the reference parameter PR is the number of pixels of the region.

4. The process as claimed in claim 2, wherein first and second sets of types Tᵢ of features are distinguished, they being such that any type Tₗ of feature of the first set corresponds to an invalidating defect and any type Tₗ of feature of the second set corresponds to a defect whose invalidating nature depends on the reference parameter PR.

5. The process as claimed in claim 4, wherein a third set of types Tᵢ of features is distinguished, it being such that no type Tᵢ of feature of the third set corresponds to a possibly invalidating defect.

6. The process as claimed in claim 1, wherein, to identify the type of the visible feature from among the types Tᵢ of feature,
a) with each discriminating parameter Pⱼ there is associated,
a fuzzy discriminating parameter PⱼF, and
for each type Tᵢ of feature, a possibility distribution Dᵢⱼ over the set of possible values of the discriminating parameter Pⱼ, this distribution expressing the degree with which it is possible for a type Tₗ of feature to be identified in view of the discriminating parameter Pⱼ,
b) the compatibility of the fuzzy parameter PⱼF with the possibility distribution Dᵢⱼ is evaluated so as to deduce the possibility Aᵢⱼ of having identified the type Tᵢ of feature in view of the discriminating parameter Pⱼ.

7. The process as claimed in claim 6, wherein,
at least two distinct discriminating parameters Pⱼ, Pₖ are calculated and
for each type Tᵢ of feature, the two corresponding possibilities Aᵢⱼ, Aₗₖ of having identified the type Tᵢ of feature in view of the two discriminating parameters Pⱼ, Pₖ are calculated and the minimum possibility min (Aₗⱼ, Aᵢₖ) of having identified the type Tᵢ of feature is determined, and
the minimum possibilities min (Aᵢⱼ, Aᵢₖ) of each type Tₗ of feature are intercompared so as to decide which of the types Tᵢ of feature corresponds to the visible feature.

8. The process as claimed in claim 7, wherein the type of the visible feature is considered to be the type Tᵢ of feature having the highest minimum possibility min (Aᵢⱼ, Aᵢₖ).

9. The process as claimed in claim 7, wherein the type of the visible feature is considered to be the type Tᵢ of feature having the highest minimum possibility min (Aᵢⱼ, Aᵢₖ), on condition that this highest minimum possibility min(Aᵢⱼ, Aᵢₖ) is greater than a predetermined threshold.

10. The process as claimed in claim 7, wherein the type of the visible feature is considered to be the type Tᵢ of feature having the highest minimum possibility min (Aᵢⱼ, Aᵢₖ), on condition that the difference between the highest minimum possibility min (Aᵢⱼ, Aᵢₖ) and the lowest minimum possibility min (Aₗⱼ, Aₗₖ) is greater than a predetermined threshold.

11. The process as claimed in claim 1, wherein, should it be decided that the quality of the article is inadequate, the latter is sent to a recycling or rejection chain which depends on the type Tₗ of feature identified.

12. The process as claimed in claim 1, wherein each discriminating parameter of a region (R1, R2) is chosen from among parameters characterizing the aspect ratio of the region (R1, R2), the orientation of this region with respect to a reference direction (V), the shape of the region (R1, R2) with respect to a reference shape, such as a rectangle encompassing this region (R1, R2) or the perforated look of the region (R1, R2).

13. The process as claimed in claim 1, wherein at least three distinct types Tᵢ of features are defined.

14. The process as claimed in claim 1, wherein the article is made of glass and constitutes for example a container.

15. The process as claimed in claim 1, wherein it is implemented by a computer program.
